(19) United States
(12) Patent Application Publication
(10) Pub. No.: US 2016/0321560 A1
(43) Pub. Date: Nov. 3, 2016

(54) OPPORTUNITY SURFACING MACHINE LEARNING FRAMEWORK

(71) Applicant: Microsoft Technology Licensing, LLC, Redmond, WA (US)

(72) Inventors: Babak Nakhayi Ashtiani, Sammamish, WA (US); Sachin S. Panvalkar, Sammamish, WA (US); Daniel De Freitas Adiwardana, Bellevue, WA (US)

(21) Appl. No.: 14/701,104

(22) Filed: Apr. 30, 2015

(51) Int. Cl. G06N 99/00; G06F 3/0484; G06F 7/08; G06F 3/0487

(52) U.S. Cl. CPC G06N 99/005; G06F 3/0487; G06F 3/0484; G06F 7/08

(57) ABSTRACT

An opportunity surfacing architecture for surfacing an opportunity to a user in a computing system comprises, in one example, a user interface component and a machine learning framework configured to detect first inputs indicative of an opportunity performance history of a user and to detect second inputs indicative of a new opportunity. The machine learning framework is configured to generate a user-specific indicator for the new opportunity based on the opportunity performance history. The opportunity surfacing architecture comprises an opportunity surfacing system configured to control the user interface component to generate a user interface display that displays a representation of the new opportunity to the user based on the user-specific indicator.

### BACKGROUND

Organizations typically include users that perform various tasks and activities in fulfillment of organizational operations. For example, a service industry or project-based organization has projects that are broken down into activities. Each activity needs to be performed in order to complete the project.

Often, the organization employs a dedicated resource manager who needs to locate and assign resources to the project. For example, a given project may have a planning phase where a number of activities are performed in order to plan the project. It may then be followed by a design phase where components of the project are designed, and a build phase where the components are built, and finally a test phase, where the system is tested. Each activity may require a number of different resources for its completion. For instance, during the design phase, the needed user resources may include various types of engineers, supervisors, programmers, etc. Of course, this activity breakdown structure is exemplary only. In actuality, the activity breakdown structure may have far more phases, each with many activities and requiring many different types of resources.

Identifying user resources that are not only qualified to perform the activities, but that are also available during the time frame needed by the project, is a manually intensive process. This often involves the project manager (or other user) searching for individuals who may have the skills to perform the activities based on profiles maintained by the individuals.

The discussion above is merely provided for general background information and is not intended to be used as an aid in determining the scope of the claimed subject matter.

### SUMMARY

An opportunity surfacing architecture for surfacing an opportunity to a user in a computing system comprises, in one example, a user interface component and a machine learning framework configured to detect first inputs indicative of an opportunity performance history of a user and to detect second inputs indicative of a new opportunity. The machine learning framework is configured to generate a user-specific indicator for the new opportunity based on the opportunity performance history. The opportunity surfacing architecture comprises an opportunity surfacing system configured to control the user interface component to generate a user interface display that displays a representation of the new opportunity to the user based on the user-specific indicator.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of an opportunity surfacing architecture.

FIG. 2 is a block diagram of one example of a machine learning recommendation framework.

FIG. 3 is a flow diagram of one example of a method for training a machine learning recommendation framework.

FIG. 4 is a flow diagram of one example of a method for generating a user-specific indicator for a new opportunity.

FIG. 5 is a block diagram of one example of a recommendation system.

FIG. 6 is a flow diagram of one example of a method for surfacing opportunities to a user.

FIG. 7 is a screenshot of one example of a user interface for displaying recommended work opportunities to a user.

FIG. 8 is a screenshot of one example of a user interface having filter user input mechanisms for filtering recommended work opportunities.

FIG. 9 is a screenshot of one example of a user interface for displaying recommended work opportunities to a user.

FIG. 10 is a screenshot of one example of a user interface showing additional details for a recommended work opportunity.

FIG. 11 is a screenshot of one example of a user interface for a work opportunity request.

FIG. 12 is a flow diagram of one example of a method for re-training a machine learning recommendation framework.

FIG. 13 is a block diagram showing one example of the architecture illustrated in FIG. 1, deployed in a cloud computing architecture.

FIG. 14-18 show various examples of mobile devices that can be used with the architecture shown in FIG. 1.

FIG. 19 is a block diagram of one example computing environment.

### DETAILED DESCRIPTION

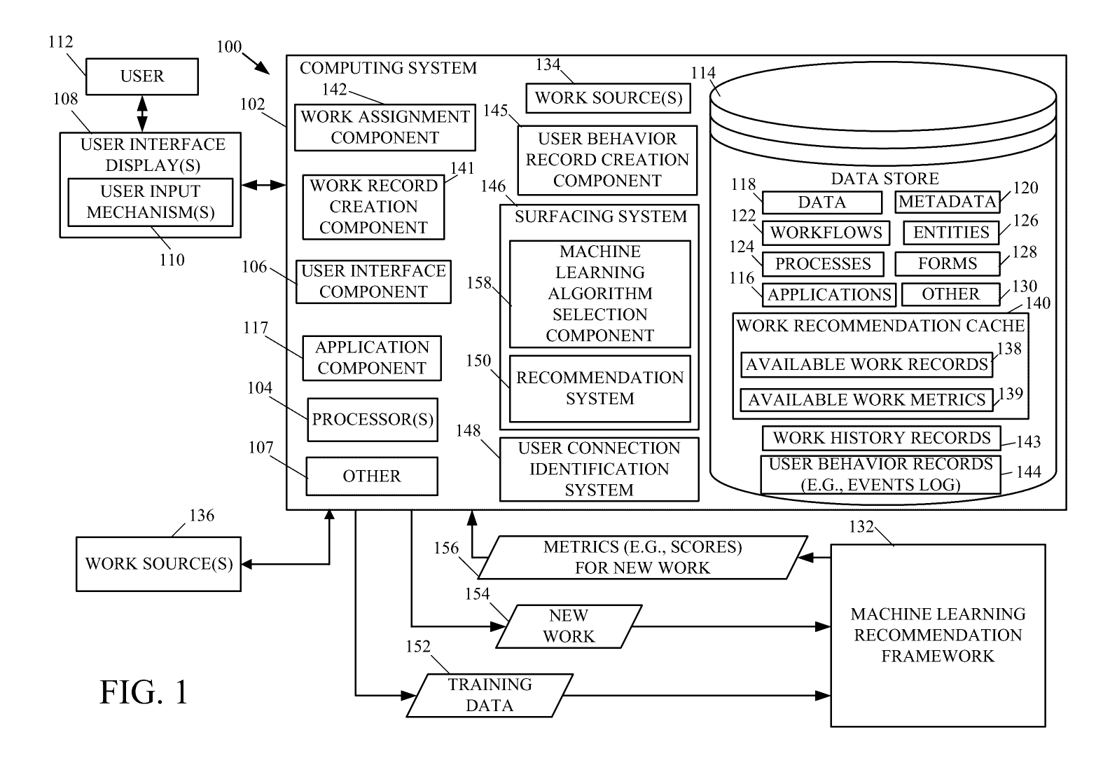

FIG. 1 is a block diagram of one example of an opportunity surfacing architecture 100. Architecture 100 includes a computing system 102 that is accessible by one or more users through one or more user interface displays. A user interface component 106 generates user interface display(s) 108 with user input mechanisms 110, for interaction by a user 112. In FIG. 1, a single user 112 is illustrated interacting with computing system 102, for sake of illustration. However, in other examples, any number of users may interact with computing system 102. Computing system 102 can include other items 107 as well.

User 112 can access computing system 102 locally or remotely. In one example, user 112 uses a client device that communicates with computing system 102 over a wide area network, such as the Internet. User 112 interacts with user input mechanisms 110 in order to control and manipulate computing system 102. For example, using user input mechanisms 110, user 112 can access data in a data store 114.

User input mechanisms 110 sense physical activities, for example by generating user interface display(s) 108 that are used to sense user interaction with computing system 102. The user interface display(s) 108 can include user input mechanism(s) 110 that sense user input in a wide variety of different ways, such as point and click devices (e.g., a computer mouse or track ball), a keyboard (either virtual or hardware), and/or a keypad. Where the display device used to display the user interface display(s) 108 is a touch sensitive display, the inputs can be provided as touch gestures. Similarly, the user inputs can illustratively be provided by voice inputs or other natural user interface input mechanisms as well.

Computing system 102 can be any type of system accessed by user 112. In one example, but not by limitation, computing system 102 comprises an electronic mail (e-mail) system, a collaboration system, a document sharing system, a scheduling system, and/or an enterprise system. In one example, computing system 102 comprises a business system, such as an enterprise resource planning (ERP) system, a customer resource management (CRM) system, a line-of-business system, or another business system.

As such, computing system 102 includes applications 116 that can be any of a variety of different application types. Applications 116 are executed using an application component 117 that facilitates functionality within computing system 102. By way of example, application component 116 can access information in data store 114. For example, data store 114 can store data 118 and metadata 120. The data and metadata can define work flows 122, processes 124, entities 126, forms 128, and a wide variety of other information 130. By way of example, application component 116 accesses the information in data store 114 in implementing programs, workflows, or other operations performed by application component 116.

Computing system 102 includes one or more processors 104. Processor 104 comprises a computer processor with associated memory and timing circuitry (not shown). Processor 104 is illustratively a functional part of system 102 and is activated by, and facilitates the functionality of, other systems, components and items in computing system 102.

FIG. 1 shows a variety of different functional blocks. It will be noted that the blocks can be consolidated so that more functionality is performed by each block, or they can be divided so that they functionality is further distributed. It should also be noted that data store 114 can be any of a wide variety of different types of data stores. Further, data store 114 can be stored in multiple data stores. Also, the data stores can be local to the environments, agents, modules, and/or components that access them, or they can be remote therefrom and accessible by those environments, agents, modules, and/or components. Similarly, some can be local while others are remote.

By way of example, computing system 102 may be utilized by an organization to perform various activities and tasks in fulfillment of organizational operations. For example, a service industry or project-based organization may have opportunities for user 112 to perform these various functions. An opportunity comprises a unit of work to be performed by a user either individually, or as part of a team or collection of workers. Work includes, but is not limited to, an activity, job, task, set of tasks, project, or any other opportunity for a user.

In some environments, a resource manager of an organization is employed to manually locate and assign users and other resources to the work to be completed. This process is very time consuming, cumbersome, and labor intensive. Further, it is often difficult to identify workers who may have the requisite skills, time, and interest to perform the work.

Embodiments described herein provide a number of features and advantages. By way of illustration, example opportunity surfacing architecture 100 employs a user resource centric approach that is supply or workforce oriented. Architecture 100 provides the users who may perform the work visibility into the various work opportunities. As discussed in further detail below, described embodiments advantageously aid organizations in increasing resource utilization, retaining top worker talent, and decreasing operations cost by recommending relevant work to the users.

In the example of FIG. 1, architecture 100 employs a machine learning recommendation framework 132 that utilizes user work history, user work preferences, and/or user connections to surface work opportunities to a user. This resource centric approach can reduce the need to have a dedicated resource manager who assigns resources to work and improve the user experience in finding relevant work that is of interest to the user. Further, the machine learning recommendation framework 132, in one example, creates a dynamic user profile based on the user's work history and/or behavior without the need for the user to directly interact with and maintain the user profile. Disclosed embodiments can improve the user experience in the work assignment process and work proficiency, which can reduce organizational overhead as it does not require, for example, a project manager to run a resource assignment process for assigning user resources to a project.

As shown in FIG. 1, architecture 100 includes one or more sources of work. This can include sources that are internal to computing system 102 (i.e., work source(s) 134) and/or external to computing system 102 (i.e., work source(s) 136). By way of example, work source(s) 134 can include tasks defined by a project manager that are to be performed within an organization utilizing data 118, workflows 122, processes 124, etc. For instance, the organization may require that a software component is built. In this case, a new unit of work may comprise a programming job for a portion of the software component. An external work source 136 can comprise a third party organization that requires, for example, a consultant to perform various activities.

Work sources 134 and/or 136 provide new work inputs to a work record creation component 141 that indicate new work opportunities to be performed. These inputs can include various parameters and requirements for the work opportunities, such as user requirements defined in terms of skill, experience, certifications, education, or other information. Work record creation component 141 creates available work records 138 to include the parameters and requirements for the work opportunities. The available work records 138 can be stored in work recommendation cache 140.

A work assignment component 142 is configured to assign an available work record 138 to one or more users who are to perform the corresponding work opportunity. For example, if user 112 is assigned to a given project or job, work assignment component 142 can send notifications to user 112 that they have been assigned to the given project, and also identify the work specifics. Work assignment component 142 can store this work assignment in data store 114 and/or communicate the work assignment to the corresponding work source from which the work opportunity originated.

Data store 114 can also store work history records 143 and user behavior records 144. In one example, work history records 143 are generated by work record creation component 141 and identify a history of work performance relative to one or more users of computing system 102. For example, a given work history record 143 can identify a unit of work that has been performed by one or more users (e.g., user 112) as well as identify various attributes and parameters of that work. One example of a work history record 143 identifies the work that was performed (for example using a work ID) and the user(s) (for example using user ID(s)) that worked on the corresponding unit of work. The work history record 143 can also identify the required skills, requires roles, location, and/or number of hours required for the work. In one example, the work history record 143 can also indicate user performance on the work, for example based on feedback from an administrator, a work manager, and/or the users themselves. As new work is assigned to and/or completed by users, work history records 143 are updated accordingly.

Computing system 102 also includes a user behavior record creation component 145 that is configured to create user behavior records 144 that represent user behavior relative to computing system 102. For example, user behavior records 144 can comprise event logs that describe various user actions through user interface displays 108. By way of example, but not by limitation, an event log can identify that a user clicked on a particular available unit of work to view additional details for the work and/or applied for the unit of work. One example of user behavior record 144 identifies the user (by a user ID for example) the type of behavior or event (e.g., work applied for, work details viewed, etc.). In one example, a user behavior record 144 also identifies the corresponding work (for example by a work ID) and/or work details (e.g., a type of work, a location, required skills, required role, etc.). User behavior records 144 can be stored, in one example, as a table.

Computing system 102 also includes a surfacing system 146 and a user connection identification system 148. Surfacing system 146 is configured to control user interface component 106 to generate user interfaces that surface available work opportunities to user 112. Surfacing system 146 includes a recommendation system 150 that generates recommendations to user 112 for the available work opportunities. As discussed in further detail below, in one example, a work opportunity is recommended to user 112 based on the user's past work history and/or user behavior identified based on records 143 and 144, respectively.

User connection identification system 148 identifies connections between users of architecture 100. For example, user connection identification system 148 connects users based on interactions and gives weights to those connections, for example using a bi-directional graph or model. Examples of interactions include, but are not limited to, electronic communications (e.g., emails, instant messaging communications, etc.), phone calls, past work interactions.

While computing system 102 and machine learning recommendation framework 132 is shown as separate blocks in FIG. 1, in one example, some or all components of framework 132 can reside in computing system 102. Framework 132 utilizes machine learning algorithms which process work opportunities to generate work opportunity indicators using user-specific data that is learned by framework 132. An output of framework 132 is utilized by recommendation system 150 to surface the work opportunities to user 112. In the illustrated example, machine learning recommendation framework 132 receives training data 152 that is utilized to train the framework for surfacing user-specific work opportunity recommendations.

In FIG. 1, a new work 154 input is provided to framework 132 that identifies a new work opportunity. Machine learning recommendation framework 132, trained using training data 152, utilizes a machine learning algorithm to generate a user-specific indicator for the new work 154 that is provided to recommendation system 150. In the illustrated example, this user-specific indicator comprises metrics 156, such as scores, for new work 154. These metrics 156 can be stored in work recommendation cache 140 as available work metrics 139.

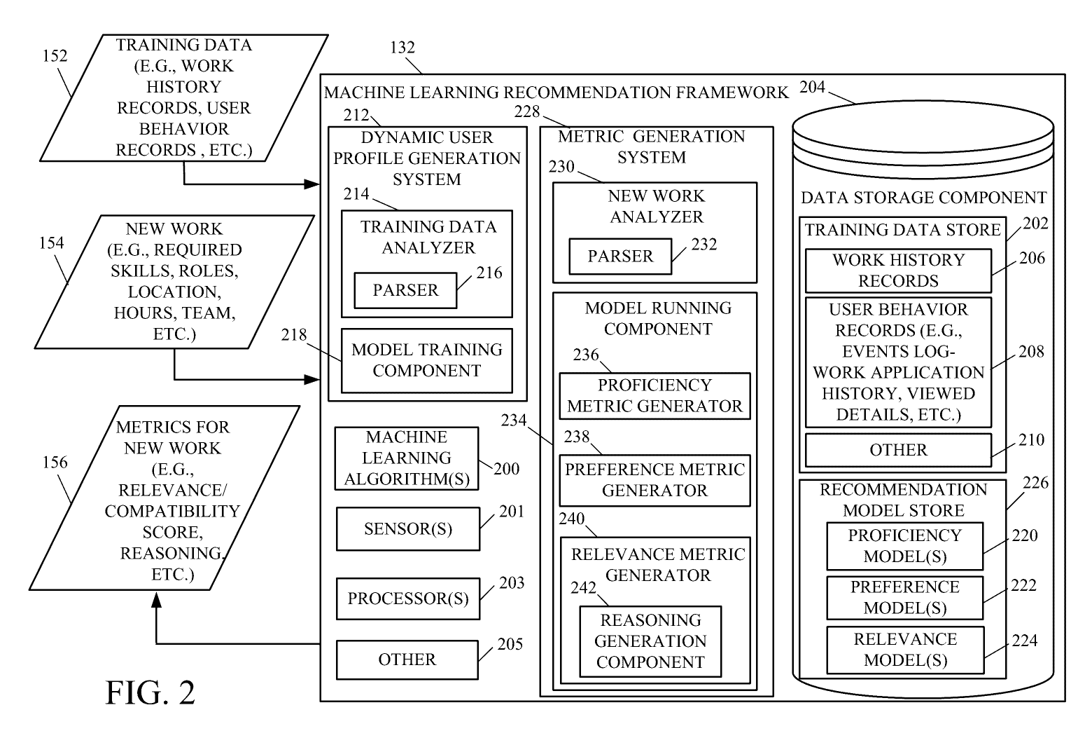

FIG. 2 illustrates one example of machine learning recommendation framework 132. Framework 132 includes one or more machine learning algorithms 200 that are utilized to train framework 132 utilizing training data 152, one or more sensors 201 configured to detect the inputs to framework 132 (e.g., training data 152, new work 154, etc.), and a data storage component 204. Framework 132 can also include one or more processors 203, and can include other items 205 as well.

The machine learning algorithm utilized by framework 132 can comprise any suitable algorithm. Some examples include, but are not limited to, linear regression, collaborative filtering, and content based filtering algorithms. In one example, the machine learning algorithm employed by machine learning recommendation framework 132 is dynamically selected during runtime using a machine learning algorithm selection component 158 (illustrated in FIG. 1). For example, machine learning algorithm selection component 158 can select a particular machine learning algorithm, from a collection of available algorithms, based on the data available for machine learning recommendation framework 132. By way of illustration, architecture 100 can switch between machine learning algorithms based on the quantity and quality of the data being provided to machine learning recommendation framework 132.

Referring again to FIG. 2, machine learning recommendation framework 132 receives training data 152, which can be stored in a training data store 202. The training data includes work history records 206 and user behavior records 208. Training data store 202 can store other information 210 as well.

Framework 132 includes a dynamic user profile generation system 212 that is configured to generate a dynamic user profile based on training data 152. The user profile is dynamic in that it is actively generated and updated as new training data 152 becomes available. This dynamically created user profile does not require direct user interaction to create, update, or maintain the profile.

User profile generation system 212 includes a training data analyzer 214, including a parser 216. Parser 216 parses training data 152 to identify its parameters. For example, a work history record can be parsed to identify parameters such as a work ID, user ID(s), required skills for the work, requires roles for the work, user work performance, and a location of the work. Using the parsed training data, a model training component 218 trains one or more recommendation models that are stored in recommendation model store 226. In the illustrated example, the recommendation models include proficiency models 220, preference models 222, and relevance models 224.

Each proficiency model 220 is trained for a particular user (e.g., user 112) using the user's work history training data. The proficiency model models user proficiency on different work item requirements given the user's work history. This can include, but is not limited to, building a categorical histogram based on the user's work experience to personalize the proficiency model for the user.

By way of example, a profile of user 112 is generated by system 212 inferring attributes of user 112, such as the user's skills, role, and location, from the work history of user 112. The proficiency model 220 for user 112 models user 112's proficiency on work relative to these attributes.

Each preference model 222 models preferences for a particular user (e.g., user 112) using the user's behavior training data and/or work history training data. Each relevance model 224 models how to combine the outputs from proficiency model 220 and preference model 222 to obtain a combined relevance output, such as by weighting the outputs.

Framework 132 includes a metric generation system 228 that is configured to generate a user-specific indicator, such as metrics 156, for new work 154. Metrics 156 can comprise a score or a set of scores computed for new work 154. Of course, other forms of metrics can be utilized.

In one example, an identification of the user(s) for which metrics 156 will be generated for new work 154 can be provided along with new work 154, or can be separately provided to machine learning recommendation framework 132. Metric generation system 228 uses the user identification to select the corresponding recommendation models for use in generating metrics 156.

Metric generation system 228 includes a new work analyzer 230. Analyzer 230 includes a parser 232 configured to parse new work 154 to identify its parameters, such as, but not limited to, required roles, required skills, a location, a number of required hours, and/or a team or group of other users assigned to or otherwise associated with new work 154.

Metric generation system 228 comprises a model running component 234 configured to run the trained models. For example, model running component 224 includes a proficiency metric generator 236 configured to generate a proficiency metric using proficiency model 220, a preference metric generator 238 configured to generate a preference metric using preference model 222, and a relevance metric generator 240 configured to generate a relevance metric using relevance model 224.

By way of example, the proficiency metric generated by proficiency metric generator 236 is indicative of a similarity of new work 154 to the user's work history. Proficiency metric generator 236 uses the learned user work proficiency, learned from training proficiency model 220, to generate the proficiency metric. The preference metric generated by preference metric generator 238 indicates a similarity of the new work 154 to the user's preferences. The relevance metric generated by relevance metric generator 230 is obtained by combining the proficiency metric and preference metric using relevance model 224.

In one example, a reasoning generation component 242 is configured to output a reasoning metric that is indicative of a recommendation reasoning or basis for the relevance metric. For example, the reasoning metric can comprise a set of sub-scores for each work item requirement that indicates the degree to which it influenced the metrics. For sake of illustration, the set of sub-scores can indicated that a user is proficient at new work 154 because the user appears to be good at a particular programming language required by new work 154. In another example, the set of sub-scores can indicate that new work 154 is preferred by the user because the user appears to like a given programming language based on their past behavior. Some or all of the metrics generated by metric generation system 228 are output for use by recommendation system 150.

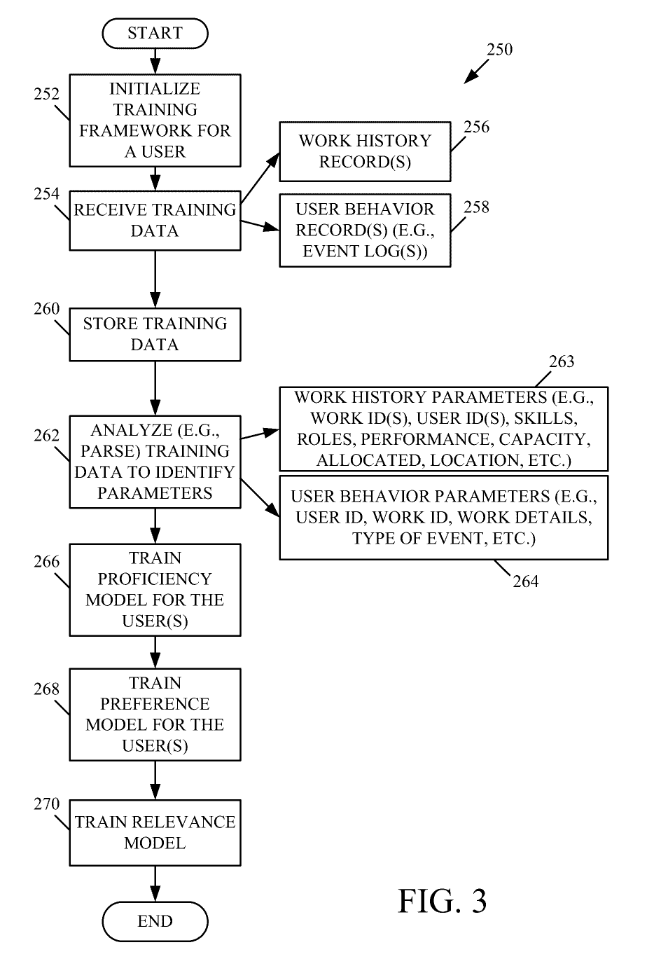

FIG. 3 is a flow diagram of one example of a method 250 for training a machine learning recommendation framework. For the sake of illustration, but not by limitation, method 250 will be described in the context of training machine learning recommendation framework 132 within architecture 100.

At step 252, machine learning recommendation framework 132 is initialized for a given user (i.e., user 112). This includes, in one example, user 112 signing up or registering with architecture 100 to be provided with work recommendations. Further, in initializing framework 132, initial recommendation models can be generated for user 112, for example by providing some initial information about work history, preferences, etc.

At step 254, training data 152 is received by framework 132. For example, at step 256, work history records 206 are received and, at step 258, user behavior records 208 are received. This training data can be stored in training data store 202 at step 260.

At step 262, the training data is analyzed by training data analyzer 214 to identify parameters to be used in training the recommendation models. For example, this can include identifying work history parameters at step 263 and/or user behavior parameters at step 264.

At step 266, the training data parameters as utilized to train the proficiency models 220 for the corresponding user(s). For example, work history parameters 263 identify a past unit of work performed by user 112, along with a set of skills required by that unit of work. The work history parameters 263 can also include a performance indicator relative to the unit of work, a location of the work, and/or the number of hours for the work. The proficiency model 220 for user 112 is thus trained to give a higher proficiency metric to new work having the skill set for which user 112 is identified as being proficient.

At step 268, the preference models 222 are trained for the corresponding user(s). For example, user behavior parameters 264 can identify that user 112 applied for a given unit of work. Accordingly, the preference model trained for user 112 is configured to generate a higher preference metric for new work that is similar to the work user 112 previously applied for as it indicates the user prefers that type of work. Also, the preference model 222 can be trained to give a higher preference metric to work based on recent user trends. For example, if a majority of the work history of user 112 is in a first programming language (such as C++), but the user has most recently applied for or performed work with a second programming language (such as X++), preference model 222 can be configured to give a higher preference metric to work having the second programming language as a required skill set since this indicates a recent trend or preference of the user. Also, the preference model 222 can be trained to give a higher preference metric to work based on work location. For example, the user's work history and behavior may indicate that they prefer to work within particular geographic area. In this case, preference model 222 can be configured to give a higher preference metric to work located within the particular geographic area.

At step 270, relevance models 224 are trained using the training data. As mentioned above, a relevance model 224 for user 112 models a combination of the proficiency and preference metrics in generating a combined relevant metric for the user. For example, step 270 can comprise identifying weighting factors for the proficiency and preference models to determine how much each model effects the final relevance metric.

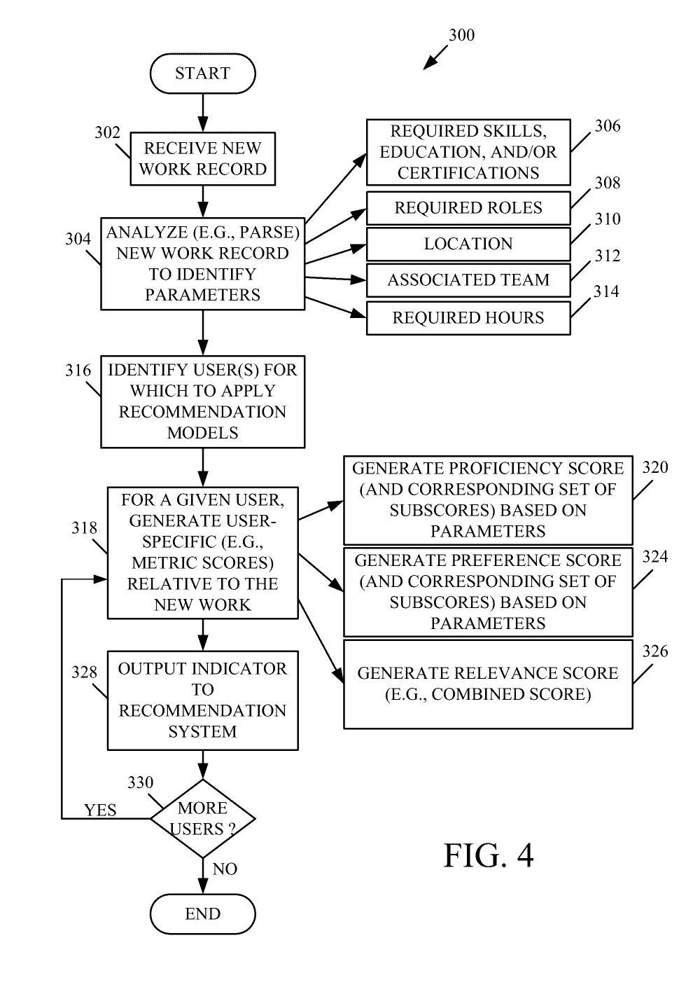

FIG. 4 is a flow diagram of one example of a method 300 for generating a user-specific indicator for a new opportunity. For sake of illustration, but not by limitation, method 300 will be described in the context of using machine learning recommendation framework 132 to generate metrics 156 for new work 154.

At step 302, a new work record is received for new work 154. At step 304, the new work record is analyzed to identify its parameters. For instance, at step 306, required skills, education, and/or certifications can be identified. At step 308, required roles are identified. At step 310, a location of the new work is identified. At step 312, a team or group of users assigned to or otherwise associated with the new work is identified. At step 314, a required number of hours for the new work is identified.

At step 316, the method identifies one or more users for which to apply recommendation models to generate metrics 156. For example, metrics 156 can be generated for a single user (e.g., user 112). In another example, a plurality of users (which may or may not include user 112) are identified.

At step 318, for each identified user, the method generates user-specific metrics (or other indicator) relative to the new work. For example, at step 320, a proficiency score is generated for the new work that indicates a similarity of the new work to work that the user has performed in the past and has been proficient or successful. In one example, generation of the proficiency score at step 320 includes generating a corresponding set of sub-scores, where each sub-score indicates a degree to which each new work parameter influenced the proficiency score. For example, one sub-score can identify a similarity between the required skills identified at step 306 and the skill set in the dynamic user profile modeled by proficiency model 220.

At step 324, a preference score is generated for the user based on the preference model 222 for the user. For example, using the preference model 222, preference metric generator 238 generates a preference score based on how close the new work is to the user preferences identified in the dynamic user profile. In one example, this includes generating a corresponding set of sub-scores which indicate a degree to which each parameter of new work 154 influenced the preference score generated at step 324. For instance, the preference model 222 may indicate that the user prefers work locations within a particular geographic region. The set of sub-scores generated at step 324 can thus include a score indicating a high preference for the new work because of the location parameter of the new work. In another example, the set of sub-scores can indicate that the work is of the type frequently applied for or viewed by the user.

At step 326, a relevance score is generated, for example by combining the proficiency and preference scores. This combination can be weighted, for example based on relevance model 224.

At step 328, the metrics are output to recommendation system 150 as an indication of recommended work. At step 330, the method determines whether there are any more users for which to generate the user-specific indications. If so, the method returns to step 318.

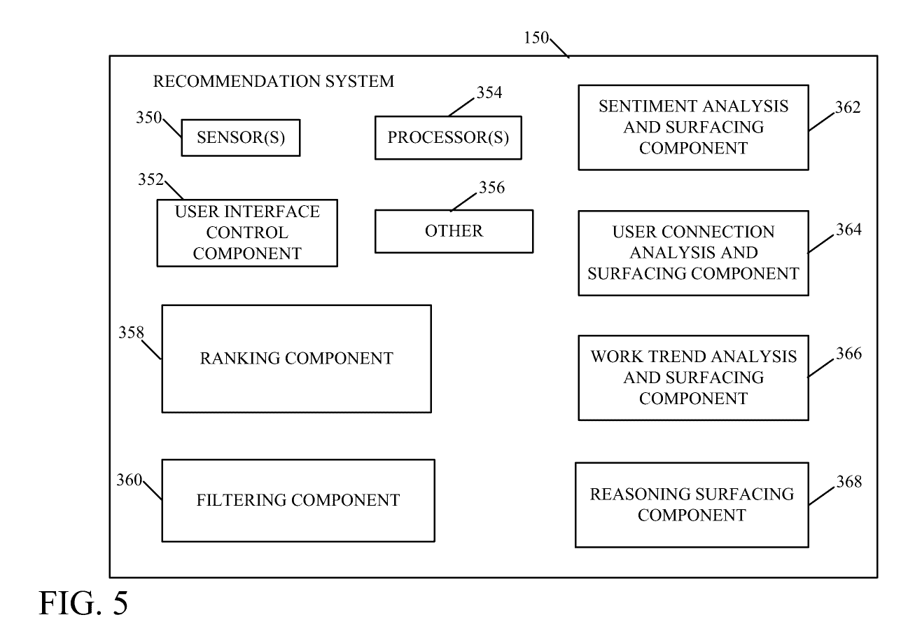

FIG. 5 is a block diagram of one example of recommendation system 150.

Recommendation system 150 includes one or more sensors 350 configured to detect inputs to recommendation system 150. For example, sensors 350 are configured to detect the metrics 156 provided from machine learning recommendation framework 132 and to detect inputs from user 112. Recommendation system 150 includes a user interface control component 352 configured to control user interface component 106 to generate user interface displays to user 112. Recommendation system 150 can include one or more processors 354, and can include other items 356 as well.

Recommendation system 150 includes a ranking component 358 and a filtering component 360. In the illustrated example, recommendation system 150 also includes a sentiment analysis and surfacing component 362, a user connection analysis and surfacing component 364, a work trend analysis and surfacing component 366, and a reasoning surfacing component 368. Ranking component 358 is configured to rank work opportunities, for example based on relevance or compatibility, for output to user 112. Filtering component 360 is configured to filter the work opportunities, for example based on user filtering inputs. Sentiment analysis and surfacing component 362 is configured to receive and analyze input from other users for work related sentiment. For example, other users of architecture 100 may provide feedback regarding an attitude or opinion for a given work opportunity. Component 362 is configured to analyze and surface this sentiment to the user.

User connection analysis and surfacing component 364 is configured to analyze and surface connections that the user has with other users. For example, a user may prefer to work with a person they have had a previous connection with on other work because they know, like, or trust that person. User connection analysis and surfacing component 364 illustratively detects inputs from user connection identification system 148 to identify a degree of connection the user has with other users who are assigned to or associated with a given work opportunity. These user connections can be used as a basis for ranking the available work opportunities for user 112.

Work trend analysis and surfacing component 366 is configured to identify work performance trends of other users and use this information to recommend work to user 112. For example, assume that user 112 has been performing significant work with on-premise cloud computing implementations, but work trend analysis and surfacing component 366 identifies that recent trends indicate other users are focusing more on off-premise cloud computing implementations. Accordingly, component 366 can rank work opportunities involving off-premise cloud computing implementations over on-premise cloud computing implementations, or otherwise suggest to the user that they may want to follow the identified work trend. In other words, work trend analysis and surfacing component 366 can help user 112 identify whether they are an outlier with respect to the work trend and that they may want to change their work focus.

Reasoning surfacing component 368 is configured to surface the reasoning information generated by reasoning generation component 242. That is, component 368 is configured to identify to user 112 a basis for the metrics 156 generated for a work opportunity.

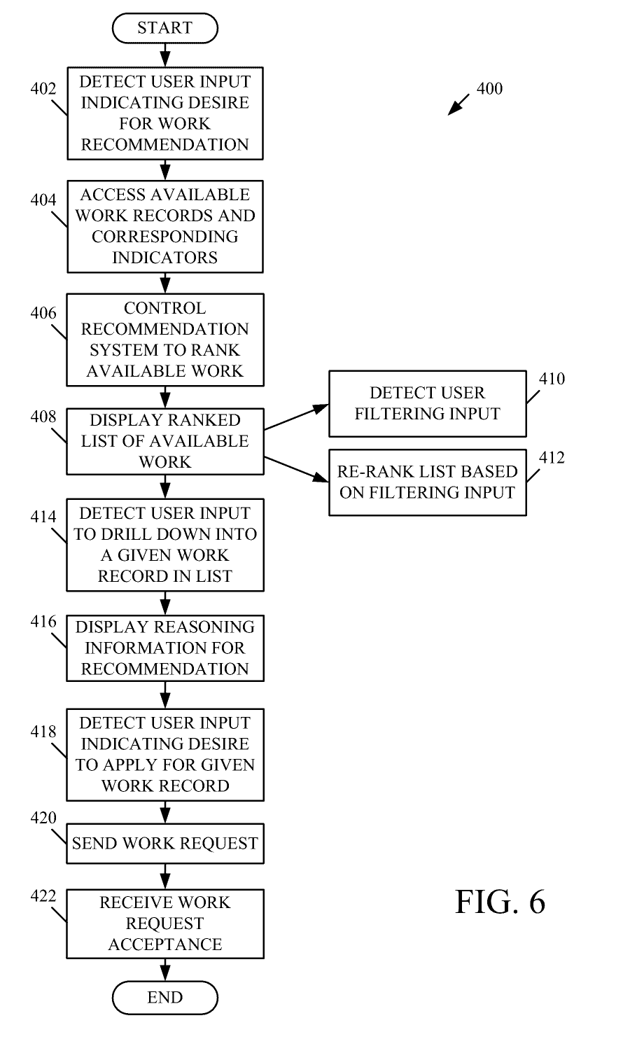

FIG. 6 is a flow diagram of one example of a method 400 for surfacing opportunities to a user. For sake of illustration, but not by limitation, method 400 will be described in the context of using recommendation system 150 to generate work recommendations for user 112.

At step 402, a user input is detected indicating a user desire for a work opportunity recommendation. For example, user 112 can provide an input through user interface displays 108 indicating that the user desires a new work assignment.

At step 404, the method accesses the available work records 138 and corresponding metrics 139 stored in data store 114. Based on the available work records 138 and corresponding metrics 139, recommendation system 150 is controlled to rank the available work based on the corresponding user-specific metrics. For example, each available work opportunity is assigned a relevance or compatibility score relative to user 112. A ranked list of available work opportunities can be displayed at step 408.

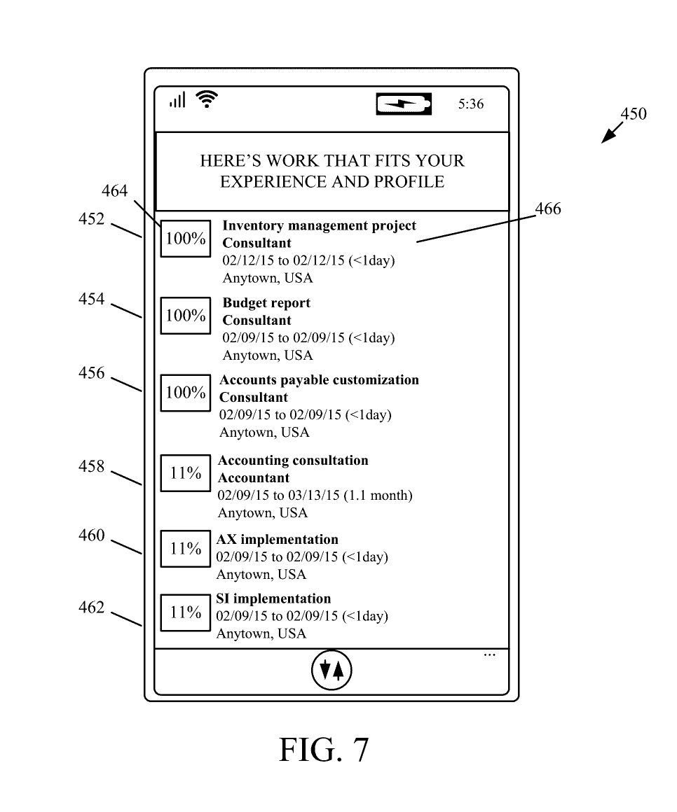

FIG. 7 illustrates one example of a user interface 450 that displays recommended work opportunities to user 112. User interface 450 displays a plurality of available work opportunity records 452-462, each record displaying a representation of the relevance or compatibility score 464 as well as a description 466 for the work record.

Referring again to FIG. 6, in one example, a user filtering input is detected. For example, user 112 may desire to filter the ranked list of available work based on any of a number of different parameters. For example, the user may wish to filter the input based on compatibility, the user's connections to other users, sentiment, work trends, or any other parameters. Further, the available work opportunity records can be filtered based on the type of work, a location of the work, a number of work hours estimated for the work, and a start date of the work. The list of available work records is re-ranked for display at step 412 based on the filtering input.

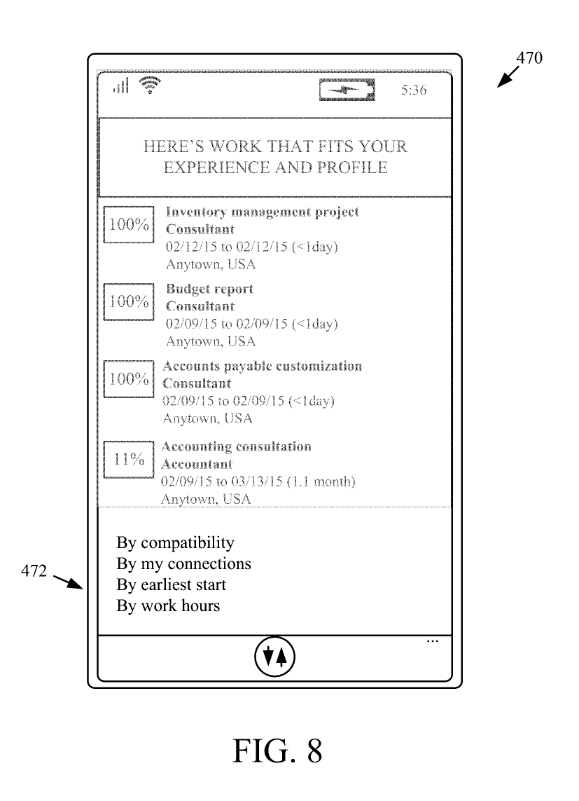

FIG. 8 is a screenshot of one example of a user interface 470 having filter user input mechanisms 472. User 112 can select one of the filter user input mechanisms 472 to filter or re-rank the list of available work opportunity records.

Referring again to FIG. 6, at step 414, a user input is detected to drill down into a given work record in the list. For example, the user can select one of the work records to view additional details about the corresponding work opportunity. For example, at step 416, the method can display reasoning information pertaining to the work opportunity.

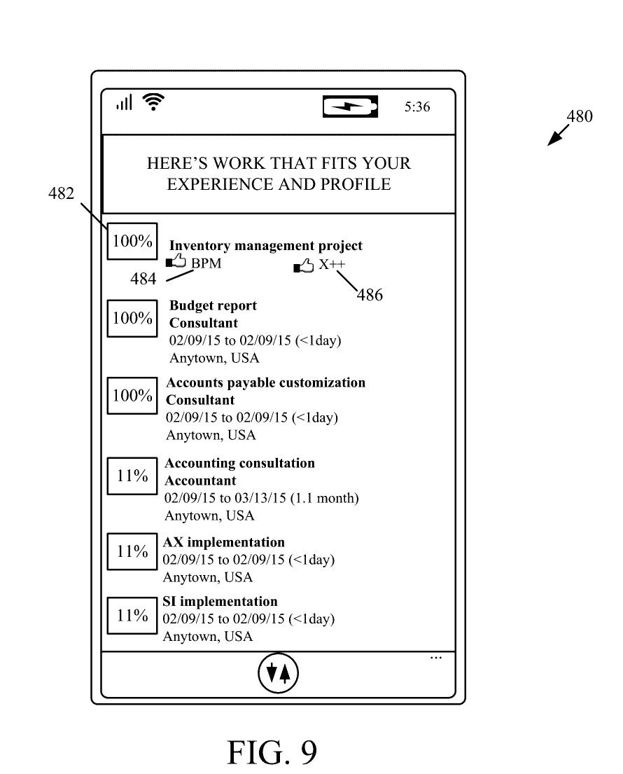

FIG. 9 illustrates one example of a user interface 480 that is displayed in response to a user input to display additional details for a work record. In FIG. 9, the user has selected a particular work record 482. In response, recommendation system 150 controls user interface component 106 to display reasoning metrics pertaining to why work record 482 was given its compatibility score. In the example of FIG. 9, work records 482 displays a user interface element 484 that indicates a user proficiency for a required skill of the work (business process management (BPM) in the present example). A user interface element 486 indicates a user preference for a parameter of the work (a required skill of X++ programming in the present example).

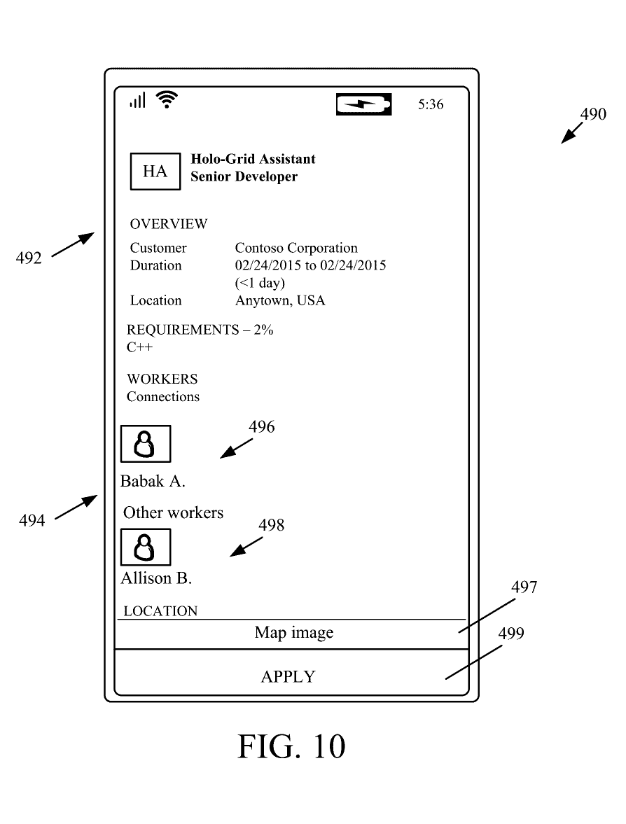

FIG. 10 illustrates one example of a user interface 490 showing additional work details. User interface 490 is displayed, in one example, in response to a user selecting a particular record in the ranked list displayed at step 408. User interface 490 includes a details section 492 that displays details for the work, and a team section 494 that displays other workers assigned to or otherwise associated with the work. In one example, team section 494 is broken down into a connections subsection 496 that identifies workers to which user 112 is connected and in other workers subsection 498 that identifies other workers that are not connections with user 112. User interface 490 also includes a location display portion 497 and a user interface element 499 for the user to submit a work application to apply for the corresponding work. In one example, portion 497 displays a map showing the location of the work.

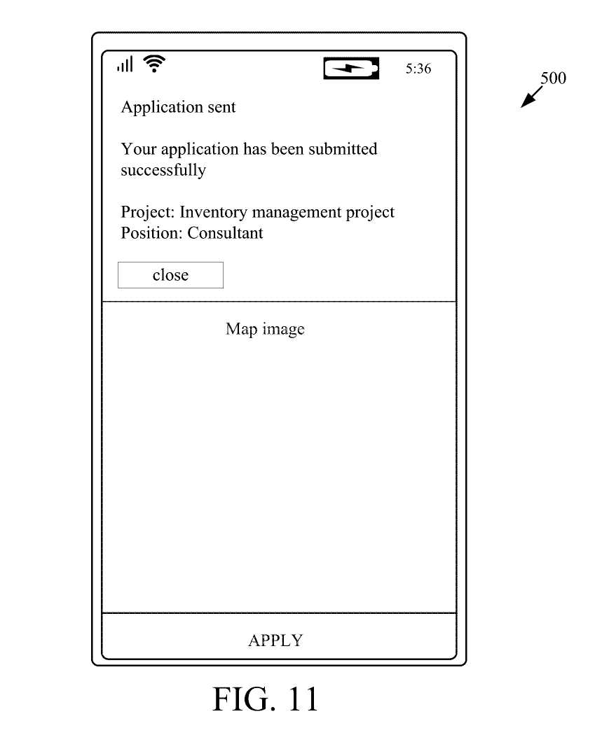

Referring again to FIG. 6, at step 418, a user input is detected indicating a user desire to apply for a given work opportunity. For example, user 112 actuates user input mechanism 499 shown in FIG. 10. At step 420, a work request is sent. For example, a work request is sent to the corresponding work source that generated the new work. Upon acceptance of the work request, a work request acceptance is received at step 422. FIG. 11 illustrates one example of a user interface 500 that is displayed in response to sending the work request at step 420.

Once the work request has been accepted at step 422, work assignment engine 142 can assign user 112 to the corresponding work opportunity. This assignment can be stored in data store 114. Additionally, in response to assignment of user 112 to the work opportunity (or alternatively in response to the user completing performance of the work), machine learning recommendation framework can be retrained using additional training data.

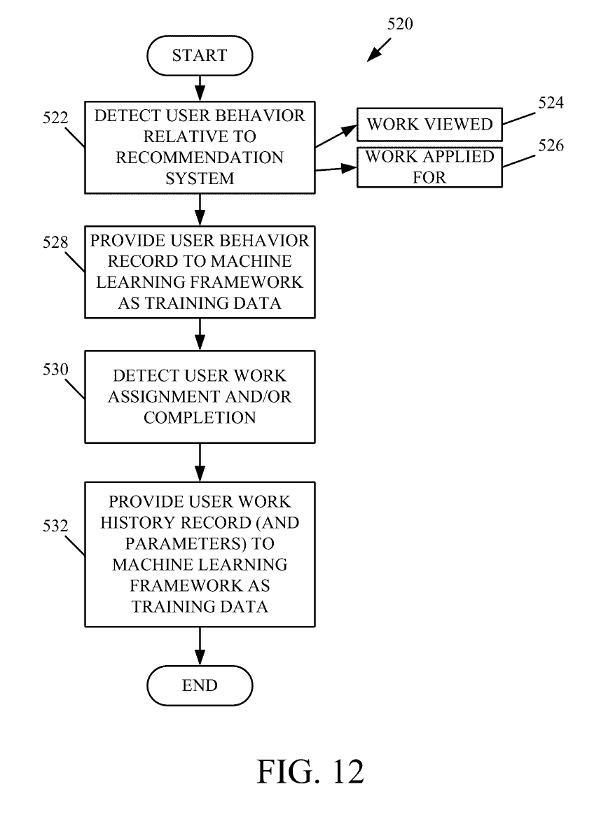

FIG. 12 is a flow diagram of one example of a method 520 for retraining a machine learning recommendation framework. For the sake of illustration, but not by limitation, method 520 will be described in the context of training machine learning recommendation framework 132 within architecture 100.

At step 522, user behavior relative to recommendation system 150 is detected. For example, step 522 can detect that the user viewed a work record or applied for a work record at steps 524 and 526, respectively.

At step 528, a user behavior record for the detected user behavior is provided to machine learning recommendation framework 132 as training data 152. Machine learning recommendation framework 132 is updated accordingly, for example by retraining the recommendation models.

At step 530 a user work assignment and/or user work completion is detected. A user work history record representing the detected user assignment and/or completion is provided to the machine learning framework, along with parameters, as training data 152. At this point, machine learning recommendation framework 132 can be updated, for example by retraining the commendation models using the training data.

It can thus be seen that the present discussion provides significant technical advantages. For example, it increases operational efficiency, and reduces organizational and computing costs associated with maintaining user profiles and assigning qualified resources to satisfy work requirements. Further, it provides an opportunity surfacing architecture that provides visibility into work that is relevant to workforce and user resources that has a high chance of performance success. This can improve the user experience as it provides visibility into what users like to work on considering their work history and preferences, and into work that has user connections.

The present discussion mentions processors and servers. In one example, the processors and servers include computer processors with associated memory and timing circuitry, not separately shown. They are functional parts of the systems or devices to which they belong and are activated by, and facilitate the functionality of the other modules, components and/or items in those systems.

Also, a number of user interface displays have been discussed. They can take a wide variety of different forms and can have a wide variety of different user actuatable input mechanisms disposed thereon. The user actuatable input mechanisms sense user interaction with the computing system. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores are also discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

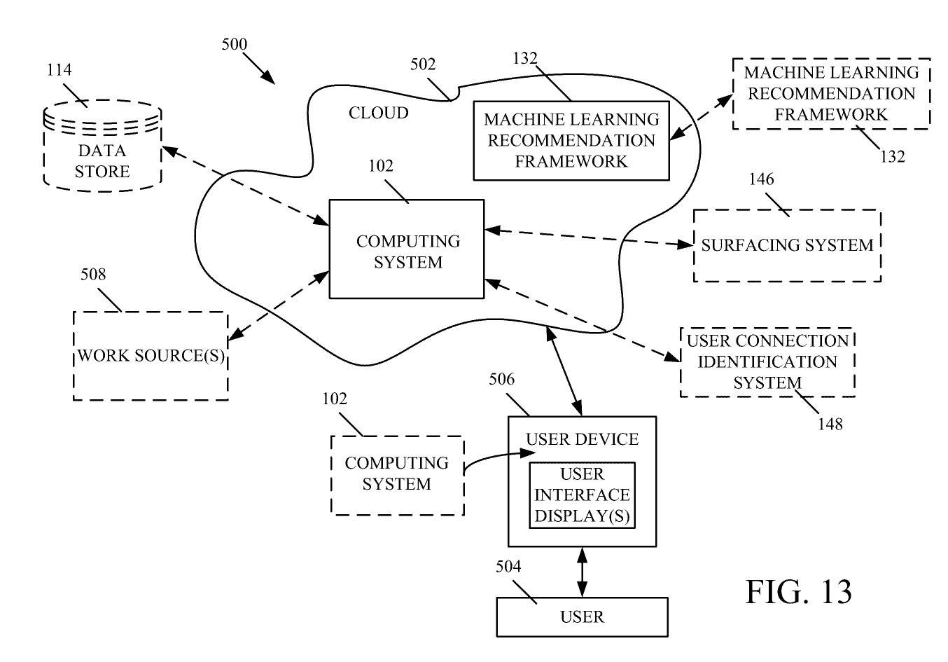

FIG. 13 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software, modules, or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the modules, components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 13, some items correspond to those shown in FIG. 1 and they are similarly numbered. FIG. 13 specifically shows that computing system 102 is located in cloud 502 (which can be public, private, or a combination where portions are public while others are private). Therefore, a user 504 (e.g., user 112) uses a user device 506 to access system 102 through cloud 502.

FIG. 13 also depicts another embodiment of a cloud architecture. FIG. 13 shows that it is also contemplated that some components of computing system 102 are disposed in cloud 502 while others are not. In one example, data store 114 can be disposed outside of cloud 502, and accessed through cloud 502. In another example, machine learning recommendation framework 132 can be disposed outside of cloud 502. In another example, work sources 508 (e.g., work sources 134 or 136) can be disposed outside of cloud 502. In another example, surfacing system 146 can be disposed outside of cloud 502. In another example, user connection identification system 148 can be disposed outside of cloud 502. Regardless of where they are located, system 102 components can be accessed directly by device 506, through a network (either a wide area network or a local area network), they can be hosted at a remote site by a service, or they can be provided as a service through a cloud or accessed by a connection service that resides in the cloud. FIG. 13 also shows that system 102, or parts of it, can be deployed on user device 506. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

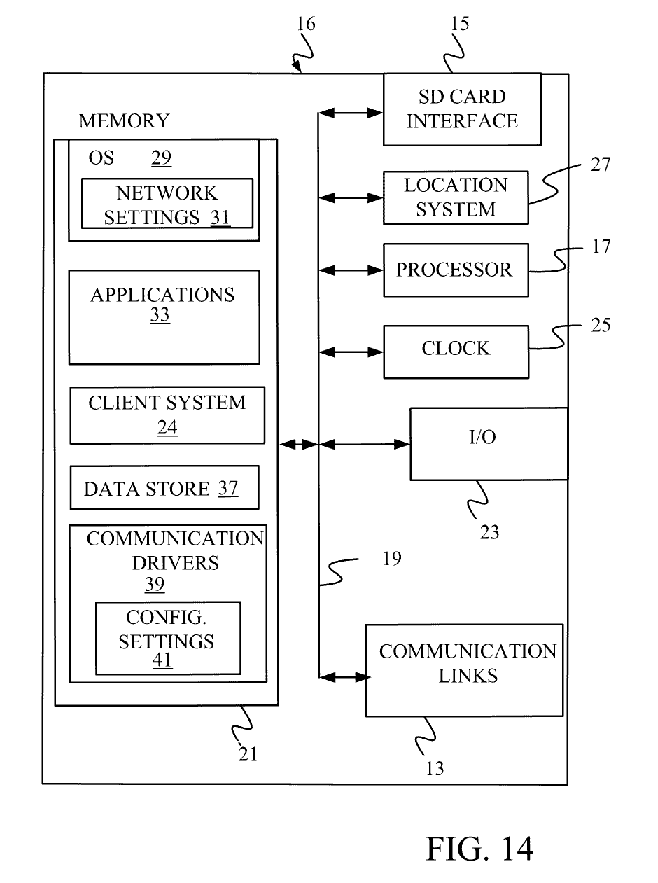

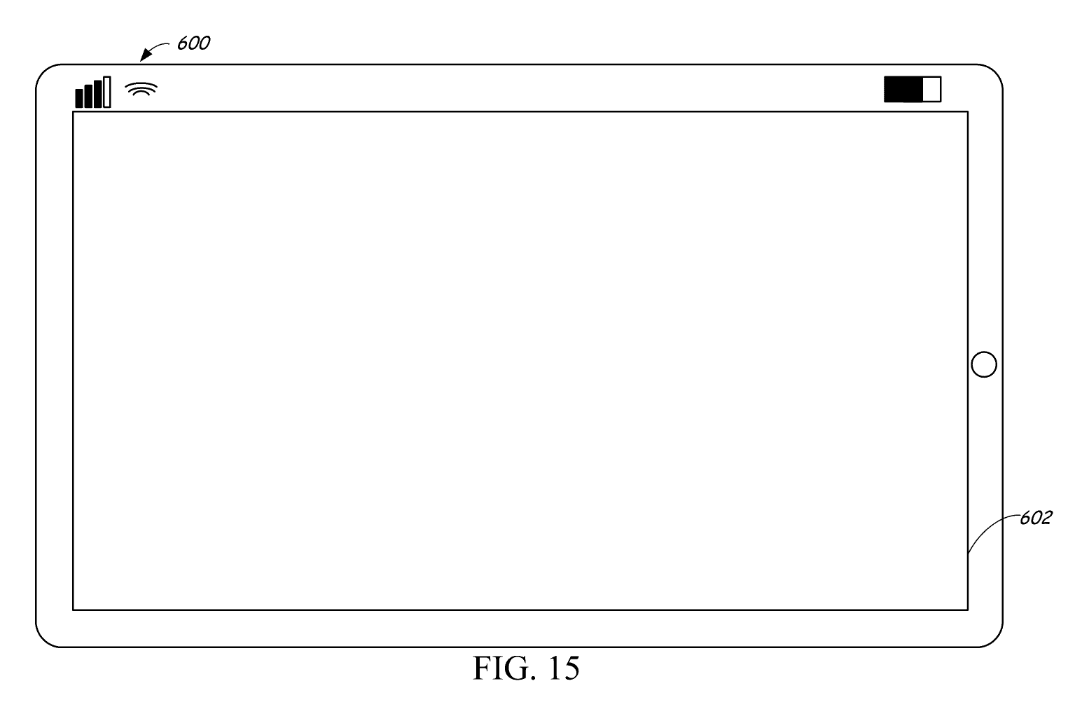

FIG. 14 is a simplified block diagram of one example of a handheld or mobile computing device that can be used as a user's or client's hand held device 16, in which the present system (or parts of it) can be deployed. FIGS. 15-18 are examples of handheld or mobile devices.

FIG. 14 provides a general block diagram of the components of a client device 16 that can run modules or components of architecture 100 or that interacts with architecture 100, or both. In the device 16, a communications link 13 is provided that allows the handheld device to communicate with other computing devices and in some examples provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

In other examples, applications or systems are received on a removable Secure Digital (SD) card that is connected to a SD card interface 15. SD card interface 15 and communications link 13 communicate with a processor 17 (which can also embody processor(s) 104 from FIG. 1, processor(s) 203 from FIG. 2, and/or processor(s) 354 from FIG. 5) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 comprises a real time clock component that outputs a time and date. It can also provide timing functions for processor 17.

Location system 27 includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. It can also store a client system 24 which can be part or all of architecture 100. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other modules or components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 15 shows one example in which device 16 is a tablet computer 600. In FIG. 15, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also receive voice inputs as well.

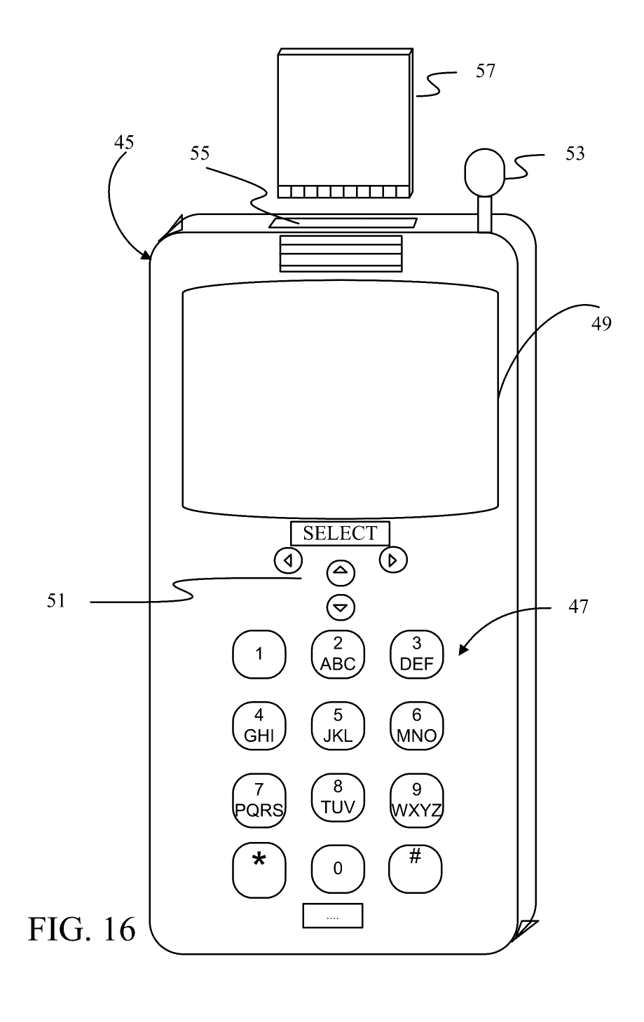

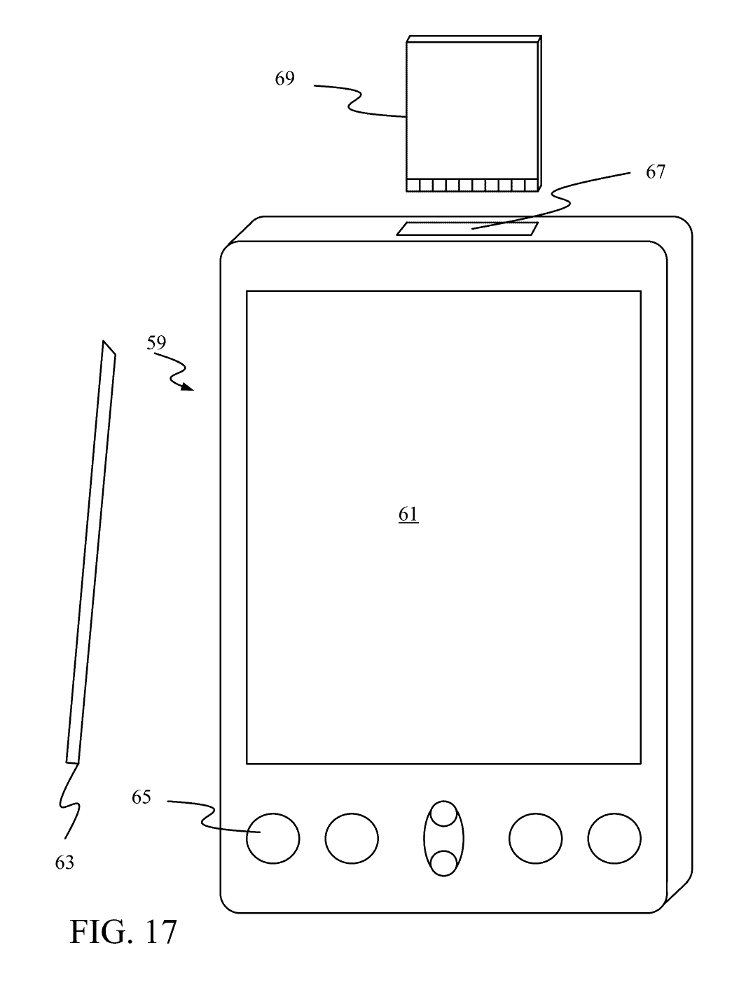

FIGS. 16 and 17 provide additional examples of devices 16 that can be used, although others can be used as well. In FIG. 16, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some examples, phone 45 also includes a Secure Digital (SD) card slot 55 that accepts a SD card 57.

The mobile device of FIG. 17 is a personal digital assistant (PDA) 59 or a multimedia player or a tablet computing device, etc. (hereinafter referred to as PDA 59). PDA 59 includes an inductive display screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display screen 61, and allow the user to change applications or select user input functions, without contacting display screen 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one example, mobile device 59 also includes a SD card slot 67 that accepts a SD card 69.

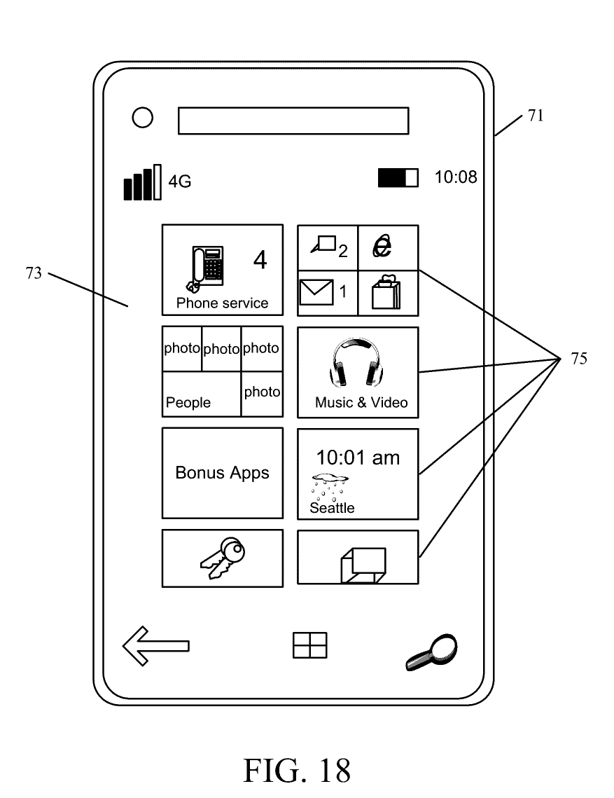

FIG. 18 is similar to FIG. 16 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

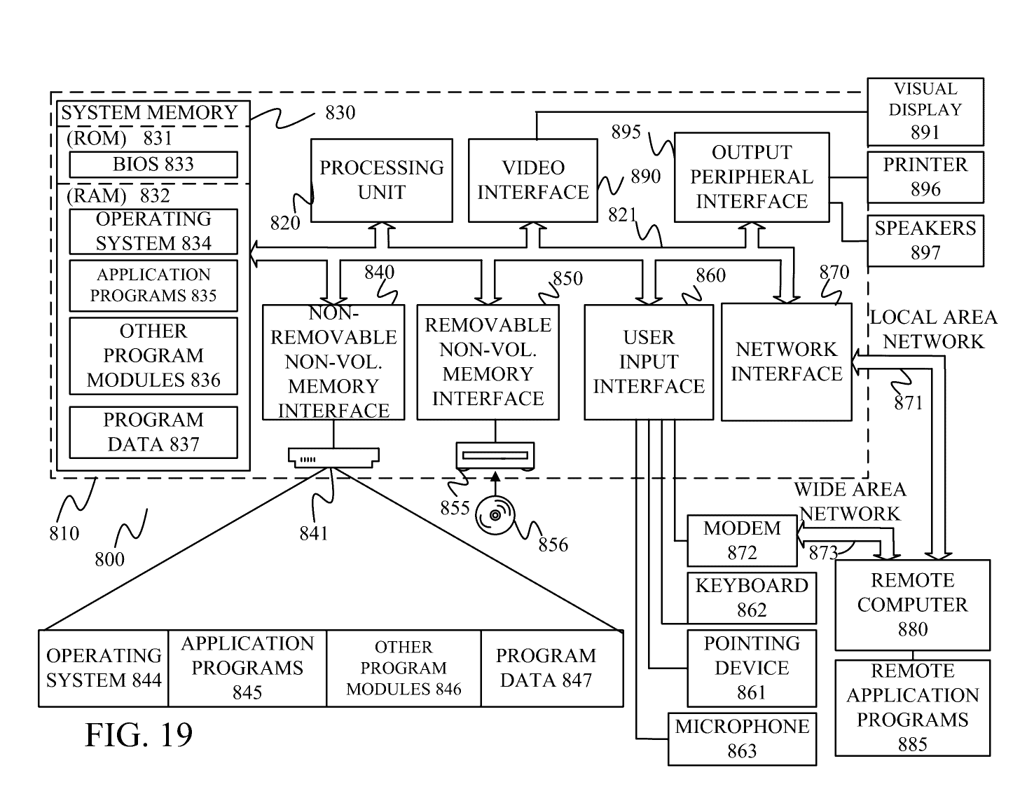

FIG. 19 is one example of a computing environment in which architecture 100, or parts of it, (for example) can be deployed. With reference to FIG. 19, an exemplary system for implementing some examples includes a general-purpose computing device in the form of a computer 810. Components of computer 810 may include, but are not limited to, a processing unit 820 (which can comprise processor(s) 104, 203, and/or 354), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 19.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 19 illustrates operating system 834, application programs 835, other program modules 836, and program data 837.

The computer 810 may also include other removable/non-removable volatile/nonvolatile computer storage media. By way of example only, FIG. 19 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 19, provide storage of computer readable instructions, data structures, program modules and other data for the computer 810. In FIG. 19, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 19 include a local area network (LAN) 871 and a wide area network (WAN) 773, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 19 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is an opportunity surfacing architecture for surfacing an opportunity to a user in a computing system. The opportunity surfacing architecture comprises a user interface component and a machine learning framework configured to detect first inputs indicative of an opportunity performance history of a user and to detect second inputs indicative of a new opportunity. The machine learning framework is configured to generate a user-specific indicator for the new opportunity based on the opportunity performance history. The opportunity surfacing architecture comprises an opportunity surfacing system configured to control the user interface component to generate a user interface display that displays a representation of the new opportunity to the user based on the user-specific indicator.

Example 2 is the opportunity surfacing architecture of any or all previous examples, wherein the opportunity performance history comprises a work history of the user, and the new opportunity comprises a new work opportunity.

Example 3 is the opportunity surfacing architecture of any or all previous examples, wherein the user-specific indicator comprises a metric for the new work computed by the machine learning framework, and the representation of the new work opportunity comprises a user recommendation for the new work displayed in the user interface display based on the metric.

Example 4 is the opportunity surfacing architecture of any or all previous examples, wherein the metric is computed by the machine learning framework based on how well the new work opportunity matches the work history.

Example 5 is the opportunity surfacing architecture of any or all previous examples, wherein the user interface display includes a reasoning metric indicative of a basis for the user recommendation.

Example 6 is the opportunity surfacing architecture of any or all previous examples, wherein the opportunity surfacing system comprises a sentiment analysis component configured to perform sentiment analysis on feedback detected from other users relative to the new work opportunity, and to control the user interface component to generate the user interface display with an indication of the sentiment analysis.

Example 7 is the opportunity surfacing architecture of any or all previous examples, wherein the opportunity surfacing system comprises a work trend analysis component configured to perform work trend analysis relative to a work history of other users, and to control the user interface component to generate the user interface display with an indication of the work trend analysis.

Example 8 is the opportunity surfacing architecture of any or all previous examples, wherein the machine learning framework is configured to generate a plurality of user-specific indicators for a plurality of new opportunities, each indicator being generated for a given one of the new opportunities based on the opportunity performance history of the user.

Example 9 is the opportunity surfacing architecture of any or all previous examples, wherein the opportunity surfacing system is configured to rank the plurality of new opportunities based on the plurality of user-specific indicators, and to control the user interface component to generate the user interface display based on the ranked plurality of new opportunities.

Example 10 is the opportunity surfacing architecture of any or all previous examples, wherein the opportunity surfacing system is configured to rank the plurality of new opportunities based on user connections the user has with other users associated with the new opportunities.

Example 11 is the opportunity surfacing architecture of any or all previous examples, wherein the user-specific indicator is based on at least one of a proficiency metric indicative of user proficiency relative to the new opportunity, or a preference metric indicative of user preference relative to the new opportunity.

Example 12 is the opportunity surfacing architecture of any or all previous examples, wherein the machine learning framework comprises a dynamic user profile generation system configured to dynamically generate a user profile based on the opportunity performance history.

Example 13 is the opportunity surfacing architecture of any or all previous examples, wherein the machine learning framework comprises a model training component configured to train one or more user-specific recommendation models.

Example 14 is the opportunity surfacing architecture of any or all previous examples, wherein the model training component is configured to detect training data comprising opportunity performance history records indicative of the opportunity performance history and user behavior records indicative of user behavior relative to the opportunity surfacing architecture.

Example 15 is the opportunity surfacing architecture of any or all previous examples, wherein the one or more user-specific recommendation models comprises:

Example 16 is the opportunity surfacing architecture of any or all previous examples, wherein the machine learning framework comprises a metric generation system. The metric generation system comprises a new opportunity analyzer configured to analyze the new opportunity to identify corresponding parameters, and a model running component configured to utilize the user-specific proficiency model to obtain a proficiency metric for the new opportunity and the user-specific behavior model to obtain a preference metric for the new opportunity.

Example 17 is the opportunity surfacing architecture of any or all previous examples, and further comprising a machine learning algorithm selection component configured to select a machine learning algorithm, from a plurality of machine learning algorithms, based on available data for the new opportunity, wherein the selected machine learning algorithm is used by the machine learning framework in generating the user-specific indicator.

Example 18 is a computing system comprising a user interface component, a sensor component configured to detect first inputs indicative of an opportunity performance history and to detect second inputs indicative of a new opportunity, and an opportunity surfacing system configured to detect a recommendation metric generated for the new opportunity based on the opportunity performance history. The opportunity surfacing system is configured to control the user interface component to generate an opportunity recommendation display that displays a representation of the new opportunity based on the recommendation metric.

Example 19 is the computing system of any or all previous examples, wherein the opportunity surfacing system comprises a ranking component configured to detect a recommendation metric generated for each of a plurality of new opportunities and to rank the plurality of new opportunities based on the detected recommendation metrics, and to control the user interface component to generate the opportunity recommendation display based on the ranked plurality of new opportunities.

Example 20 is a computer-implemented method comprising detecting a user input indicative of a user desire to perform a unit of work and identifying a plurality of available work records, each available work record corresponding to an available unit of work. The method comprises, for each available unit of work, obtaining a user proficiency metric generated for the available unit of work based on a user work history, and obtaining a user preference metric generated for the available unit of work based on user behavior. The method comprises ranking the plurality of available work records based on the user proficiency metrics and the user preference metrics, and controlling a user interface component to generate a user interface display that displays the plurality of work records based on the ranking.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. An opportunity surfacing architecture for surfacing an opportunity to a user in a computing system, the opportunity surfacing architecture comprising:
a user interface component;
a machine learning framework configured to detect first inputs indicative of an opportunity performance history of a user and to detect second inputs indicative of a new opportunity, the machine learning framework being configured to generate a user-specific indicator for the new opportunity based on the opportunity performance history; and
an opportunity surfacing system configured to control the user interface component to generate a user interface display that displays a representation of the new opportunity to the user based on the user-specific indicator.

2. The opportunity surfacing architecture of claim 1, wherein the opportunity performance history comprises a work history of the user, and the new opportunity comprises a new work opportunity.

3. The opportunity surfacing architecture of claim 2, wherein the user-specific indicator comprises a metric for the new work computed by the machine learning framework, and the representation of the new work opportunity comprises a user recommendation for the new work displayed in the user interface display based on the metric.

4. The opportunity surfacing architecture of claim 3, wherein the metric is computed by the machine learning framework based on how well the new work opportunity matches the work history.

5. The opportunity surfacing architecture of claim 3, wherein the user interface display includes a reasoning metric indicative of a basis for the user recommendation.

6. The opportunity surfacing architecture of claim 2, wherein the opportunity surfacing system comprises a sentiment analysis component configured to perform sentiment analysis on feedback detected from other users relative to the new work opportunity, and to control the user interface component to generate the user interface display with an indication of the sentiment analysis.

7. The opportunity surfacing architecture of claim 2, wherein the opportunity surfacing system comprises a work trend analysis component configured to perform work trend analysis relative to a work history of other users, and to control the user interface component to generate the user interface display with an indication of the work trend analysis.

8. The opportunity surfacing architecture of claim 1, wherein the machine learning framework is configured to generate a plurality of user-specific indicators for a plurality of new opportunities, each indicator being generated for a given one of the new opportunities based on the opportunity performance history of the user.

9. The opportunity surfacing architecture of claim 8, wherein the opportunity surfacing system is configured to rank the plurality of new opportunities based on the plurality of user-specific indicators, and to control the user interface component to generate the user interface display based on the ranked plurality of new opportunities.

10. The opportunity surfacing architecture of claim 8, wherein the opportunity surfacing system is configured to rank the plurality of new opportunities based on user connections the user has with other users associated with the new opportunities.

11. The opportunity surfacing architecture of claim 1, wherein the user-specific indicator is based on at least one of:
a proficiency metric indicative of user proficiency relative to the new opportunity; or
a preference metric indicative of user preference relative to the new opportunity.

12. The opportunity surfacing architecture of claim 1, wherein the machine learning framework comprises a dynamic user profile generation system configured to dynamically generate a user profile based on the opportunity performance history.

13. The opportunity surfacing architecture of claim 1, wherein the machine learning framework comprises a model training component configured to train one or more user-specific recommendation models.

14. The opportunity surfacing architecture of claim 13, wherein the model training component is configured to detect training data comprising opportunity performance history records indicative of the opportunity performance history and user behavior records indicative of user behavior relative to the opportunity surfacing architecture.

15. The opportunity surfacing architecture of claim 14, wherein the one or more user-specific recommendation models comprises:
a user-specific proficiency model trained based on the opportunity performance history records; and
a user-specific preference model trained based on the user behavior records.

16. The opportunity surfacing architecture of claim 15, wherein the machine learning framework comprises a metric generation system, the metric generation system comprising:
a new opportunity analyzer configured to analyze the new opportunity to identify corresponding parameters; and
a model running component configured to utilize the user-specific proficiency model to obtain a proficiency metric for the new opportunity and the user-specific behavior model to obtain a preference metric for the new opportunity.

17. The opportunity surfacing architecture of claim 1, and further comprising a machine learning algorithm selection component configured to select a machine learning algorithm, from a plurality of machine learning algorithms, based on available data for the new opportunity, wherein the selected machine learning algorithm is used by the machine learning framework in generating the user-specific indicator.

18. A computing system comprising:
a user interface component;
a sensor component configured to detect first inputs indicative of an opportunity performance history and to detect second inputs indicative of a new opportunity; and
an opportunity surfacing system configured to detect a recommendation metric generated for the new opportunity based on the opportunity performance history, and to control the user interface component to generate an opportunity recommendation display that displays a representation of the new opportunity based on the recommendation metric.

19. The computing system of claim 18, wherein the opportunity surfacing system comprises a ranking component configured to detect a recommendation metric generated for each of a plurality of new opportunities and to rank the plurality of new opportunities based on the detected recommendation metrics, and to control the user interface component to generate the opportunity recommendation display based on the ranked plurality of new opportunities.

20. A computer-implemented method comprising:
detecting a user input indicative of a user desire to perform a unit of work;
identifying a plurality of available work records, each available work record corresponding to an available unit of work;
for each available unit of work,
obtaining a user proficiency metric generated for the available unit of work based on a user work history; and
obtaining a user preference metric generated for the available unit of work based on user behavior;
ranking the plurality of available work records based on the user proficiency metrics and the user preference metrics; and
controlling a user interface component to generate a user interface display that displays the plurality of work records based on the ranking.
